(19) United States
(12) Patent Application Publication
(10) Pub. No.: US 2015/0035701 A1
(43) Pub. Date: Feb. 5, 2015

(54) GNSS RECEIVER DYNAMIC SPUR MITIGATION TECHNIQUES

(71) Applicant: QUALCOMM Incorporated, San Diego, CA (US)

(72) Inventors: Dongbo ZHANG, San Diego, CA (US); Ruben AGUINAGA, Valley Center, CA (US); Gordon G. YANG, San Diego, CA (US); Robert A. PONCE, Cupertino, CA (US)

(73) Assignee: QUALCOMM Incorporated, San Diego, CA (US)

(21) Appl. No.: 14/187,138

(22) Filed: Feb. 21, 2014

Related U.S. Application Data
(60) Provisional application No. 61/860,192, filed on Jul. 30, 2013.

(51) Int. Cl. G01S 19/21

(52) U.S. Cl. CPC G01S 19/21
USPC 342/357.59

(57) ABSTRACT

Techniques for compensating for interference in a Global Navigation Satellite System (GNSS) receiver of a mobile device are provided. An example method according to these techniques includes determining transmission band information and channel tuning information associated with an operating configuration of a Wireless Wide Area Network (WWAN) transceiver of the mobile device, identifying interference compensation data using the transmission band information and the channel tuning information for compensating for interference caused by the WWAN transceiver at the GNSS receiver, and dynamically configuring notch filters of the GNSS receiver according to the interference compensation data.

### CROSS-REFERENCE TO RELATED APPLICATIONS

This application claims the benefit of U.S. Provisional Application No. 61/860,192, filed Jul. 30, 2013, entitled “GNSS RECEIVER DYNAMIC SPUR MITIGATION TECHNIQUES,” which is assigned to the assignee hereof and incorporated herein by reference in its entirety for all purposes.

### BACKGROUND

Global Navigation Satellite System (GNSS) receivers have been incorporated into a multitude of devices, such as mobile phones, tablet computers, satellite navigation systems, and other portable devices. GNSS receivers have also been incorporated into wireless access points and terrestrial transceivers, such as femtocells to provide the wireless access point or terrestrial transceiver with precise location information.

GNSS signals are typically very weak when compared to other wireless signals that a device, such as a mobile phone or wireless base station, may receive and/or interference that may be generated by a transmitter of the device may induce in the GNSS receiver. For example, the mobile device or wireless base station may be configured to transmit Wireless Wide Area Network (WWAN) and/or Wireless Local Access Network (WLAN) signals. The signal power of the GNSS signals at the GNSS receiver may be below the thermal noise floor, and thus, the GNSS receiver may be particularly sensitive to any interference caused by the WWAN and/or WLAN transceivers. In a typical device that includes a GNSS receiver, much of the interference may be internal to the device. For example, in a mobile phone or other device that includes a GNSS receiver, sources of interference can include the phase-locked loops (PLLs) for the WWAN transceivers, the clocks that drive the digital baseband and radio frequency (RF) blocks, the loopback interference picked up from WWAN transmitters due to receiver/transmitter (Rx/Tx) antenna coupling, and/or other sources of interference. Such interference can pose a major problem for GNSS receivers as the interference may cause desense to the GNSS signals that the GNSS receiver is intended to detect. Most of the interference experienced by the GNSS receiver is narrow band in nature and can appear as a spur in the GNSS band at the GNSS receiver. Such interference is typically a magnitude stronger than the GNSS signal, and if left unmitigated, may saturate the available dynamic range of the GNSS receiver and the analog to digital converter (ADC) of the GNSS receiver. The interference may also reduce the signal-to-noise ratio of the receiver, and thus, reduce the GNSS tracking sensitivity.

In many modern mobile devices, multi-mode modems are used which have the capabilities to transmit and receive wireless signals using multiple wireless communications standards. GNSS receivers, when integrated in such a device, are susceptible to in-band spurs caused by the multi-mode modem. To make matters worse, the frequency and intensity of the spurs caused by the multi-mode modem and transceiver is usually dynamic and can change when the modem is tuned to a different wireless standard, wireless band, channel or the combination of those. Quite often, those events can happen in a very fast manner without notice in advance to the GNSS receiver and it is a big challenge for the GNSS receiver to dynamically compensate the impact of the spurs in a timely fashion. The spurs if left untreated or not treated in a timely fashion will cause desense to the GNSS receiver, reducing location fix accuracy or even rendering the GNSS receiver useless.

Conventional approaches to solving the interference problem in GNSS receivers typically involve setting up a set of fixed notch filters to compensate for the most significant spurs in the GNSS receiver. However, the effectiveness of such techniques is often limited. The center frequency and magnitude of spurs can change dynamically according to the WWAN modem status. The WWAN modem of the mobile device may be turned to different frequency bands and/or channels, and the fixed notches may not be configured to address spurs that may occur in the GNSS band may vary significantly depending on the frequency bands and/or channels to which the WWAN modem is tuned.

### SUMMARY

An example method for compensating for interference in a Global Navigation Satellite System (GNSS) receiver of a mobile device according to the disclosure includes capturing spur data for the GNSS receiver of the mobile device, the spur data representing the interference caused at the GNSS receiver by a wireless transceiver of the mobile device; processing the spur data for the GNSS receiver to generate interference compensation data; and configuring the mobile device to use the interference compensation data to dynamically configure notch filters to compensate for the interference, the interference being introduced at the GNSS receiver by the wireless transceiver of the mobile device.

Implementations of such a method may include one or more of the following features. The wireless transceiver comprises a Wireless Wide Area Network (WWAN) transceiver. Processing the spur data for the GNSS receiver to generate the interference compensation data includes generating raw notch filter configuration information from the spur data. Generating a notch filter configuration information table and a notch filter configuration information index table from the raw notch filter configuration information, wherein data in the notch filter configuration information index table provides an index to the notch filter configuration information table. The notch filter configuration information table includes frequency information associated with channels at which the wireless transceiver can be configured to operate, and the frequency information associated with a particular channel represents a frequency at which the wireless transceiver induces the interference at the GNSS receiver when the wireless transceiver is configured to operate at that frequency.

A system for compensating for interference in a Global Navigation Satellite System (GNSS) receiver of a mobile device according to the disclosure includes means for capturing spur data for the GNSS receiver of the mobile device, the spur data representing the interference caused at the GNSS receiver by a Wireless Wide Area Network (WWAN) transceiver of the mobile device; means for processing the spur data for the GNSS receiver to generate interference compensation data; and means for configuring the mobile device to use the interference compensation data to dynamically configure notch filters to compensate for the interference, the interference being introduced at the GNSS receiver by the WWAN transceiver of the mobile device.

Implementations of such a system may include one or more of the following features. The means for processing the spur data for the GNSS receiver to generate the interference compensation data includes means for generating a raw notch filter configuration information from the spur data. Means for generating a notch filter configuration information table and a notch filter configuration information index table from the raw notch filter configuration information, wherein data in the notch filter configuration information index table provides an index to the notch filter configuration information table. The notch filter configuration information table comprises frequency information associated with channels at which the WWAN transceiver can be configured to operate, and the frequency information associated with a particular channel represents a frequency at which the WWAN transceiver induces the interference at the GNSS receiver when the WWAN transceiver is configured to operate at that frequency.

A non-transitory computer-readable medium, having stored thereon computer-readable instructions for compensating for interference in a Global Navigation Satellite System (GNSS) receiver of a mobile device according to the disclosure includes computer-readable instructions comprising instructions configured to cause a computer to capture spur data for the GNSS receiver of the mobile device, the spur data representing the interference caused at the GNSS receiver by a Wireless Wide Area Network (WWAN) transceiver of the mobile device; process the spur data for the GNSS receiver to generate interference compensation data; and configure the mobile device to use the interference compensation data to dynamically configure notch filters to compensate for the interference, the interference being introduced at the GNSS receiver by the WWAN transceiver of the mobile device.

Implementations of such a non-transitory computer-readable medium may include one or more of the following features. The instructions configured to cause the computer to process the spur data for the GNSS receiver to generate the interference compensation data include instructions configured to cause the computer to generate a raw notch filter configuration information from the spur data. Instructions configured to cause the computer to generate a notch filter configuration information table and a notch filter configuration information index table from the raw notch filter configuration information, wherein data in the notch filter configuration information index table provides an index to the notch filter configuration information table. The notch filter configuration information table comprises frequency information associated with channels at which the WWAN transceiver can be configured to operate, and the frequency information associated with a particular channel represents a frequency at which the WWAN transceiver induces the interference at the GNSS receiver when the WWAN transceiver is configured to operate at the frequency.

A system for compensating for interference in a Global Navigation Satellite System (GNSS) receiver of a mobile device according to the disclosure includes a tangible, non-transitory computer-readable memory; a plurality of modules comprising processor executable code stored in the memory; a processor connected to the memory and configured to access the plurality of modules stored in the memory; and an interference determination module. The interference determination module is configured to capture spur data for the GNSS receiver of the mobile device, the spur data representing the interference caused at the GNSS receiver by a Wireless Wide Area Network (WWAN) transceiver of the mobile device; process the spur data for the GNSS receiver to generate interference compensation data; and configure the mobile device to use the interference compensation data to dynamically configure notch filters to compensate for the interference, the interference being introduced at the GNSS receiver by the WWAN transceiver of the mobile device.

Implementations of such a system may include one or more of the following features. The interference determination module being configured to process the spur data for the GNSS receiver to generate the interference compensation data is further configured to generate a raw notch filter configuration information from the spur data. The interference determination module is further configured to generate a notch filter configuration information table and a notch filter configuration information index table from the raw notch filter configuration information, wherein data in the notch filter configuration information index table provides an index to the notch filter configuration information table. The notch filter configuration information table comprises frequency information associated with channels at which the WWAN transceiver can be configured to operate, and the frequency information associated with a particular channel represents a frequency at which the WWAN transceiver induces the interference at the GNSS receiver when the WWAN transceiver is configured to operate at the frequency.

An example method for compensating for interference in a Global Navigation Satellite System (GNSS) receiver of a mobile device according to the disclosure includes determining transmission band information and channel tuning information associated with an operating configuration of a Wireless Wide Area Network (WWAN) transceiver of the mobile device; identifying notch filter configuration information using the transmission band information and the channel tuning information for compensating for WWAN interference at the GNSS receiver; and dynamically configuring notch filters of the GNSS receiver according to the notch filter configuration information.

Implementations of such a method may include one or more of the following features. Receiving the interference compensation data at the mobile device. Identifying the notch filter configuration information using the transmission band information and the channel tuning information for compensating for the WWAN interference at the GNSS receiver further comprises identifying the notch filter configuration information based at least in part on interference compensation data comprising a notch filter configuration information table and a notch filter configuration information index table associated with a band class in which the WWAN transceiver can be configured to operate. Identifying notch filter configuration information using the transmission band information and the channel tuning information comprises accessing an index value in the notch filter configuration information index table, the index value being associated with a channel information derived from the channel tuning information received from the WWAN transceiver, and accessing notch configuration data from the notch filter configuration information table using the index value from the notch filter configuration information index table. Dynamically configuring the notch filters of the GNSS receiver according to the notch filter configuration information further comprises configuring the notch filters of the using the notch configuration data from the notch filter configuration information table.

An example apparatus for compensating for interference in a Global Navigation Satellite System (GNSS) receiver of a mobile device according to the disclosure includes means for determining transmission band information and channel tuning information associated with an operating configuration of a Wireless Wide Area Network (WWAN) transceiver of the mobile device; means for identifying notch filter configuration information using the transmission band information and the channel tuning information for compensating for WWAN interference at the GNSS receiver; and means for dynamically configuring notch filters of the GNSS receiver according to the notch filter configuration information.

Implementations of such an apparatus may include one or more of the following features. Means for receiving the interference compensation data at the mobile device. The means for identifying the notch filter configuration information using the transmission band information and the channel tuning information for compensating for the WWAN interference at the GNSS receiver further comprises means for identifying the notch filter configuration information based at least in part on interference compensation data comprising a notch filter configuration information table and a notch filter configuration information index table associated with a band class in which the WWAN transceiver can be configured to operate. The means for identifying notch filter configuration information using the transmission band information and the channel tuning information comprises accessing an index value in the notch filter configuration information index table, the index value being associated with a channel information derived from the channel tuning information received from the WWAN transceiver, and accessing notch configuration data from the notch filter configuration information table using the index value from the notch filter configuration information index table. The means for dynamically configuring the notch filters of the GNSS receiver according to the notch filter configuration information further comprises configuring the notch filters of the using the notch configuration data from the notch filter configuration information table.

An example mobile device for compensating for interference in a Global Navigation Satellite System (GNSS) receiver of the mobile device according to the disclosure includes a tangible, non-transitory computer-readable memory; a plurality of modules comprising processor executable code stored in the memory; a processor connected to the memory and configured to access the plurality of modules stored in the memory; and an interference compensation module. The interference compensation module is configured to determine transmission band information and channel tuning information associated with an operating configuration of a Wireless Wide Area Network (WWAN) transceiver of the mobile device, identify notch filter configuration information using the transmission band information and the channel tuning information for compensating for WWAN interference at the GNSS receiver, and dynamically configure notch filters of the GNSS receiver according to the notch filter configuration information.

Implementations of such a mobile device may include one or more of the following features. The interference compensation module is further configured to receive the interference compensation data at the mobile device. The interference compensation module is configured to identify the notch filter configuration information based at least in part on interference compensation data comprising a notch filter configuration information table and a notch filter configuration information index table associated with a band class in which the WWAN transceiver can be configured to operate. The interference compensation module is configured to identify the notch filter configuration information based at least in part on interference compensation data is further configured to: access an index value in the notch filter configuration information index table, the index value being associated with a channel information derived from the channel tuning information received from the WWAN transceiver, and access notch configuration data from the notch filter configuration information table using the index value from the notch filter configuration information index table. The interference compensation module being configured to dynamically configure notch filters of the GNSS receiver according to the notch filter configuration information is further configured to configure the notch filters of the using the notch configuration data from the notch filter configuration information table.

An example non-transitory computer-readable medium, having stored thereon computer-readable instructions for compensating for interference in a Global Navigation Satellite System (GNSS) receiver of a mobile device, according to the disclosure includes instructions configured to cause a computer to: determine transmission band information and channel tuning information associated with an operating configuration of a Wireless Wide Area Network (WWAN) transceiver of the mobile device; identify interference compensation data using the transmission band information and the channel tuning information for compensating for interference caused by the WWAN transceiver at the GNSS receiver; and dynamically configure notch filters of the GNSS receiver according to the interference compensation data.

Implementation of such a non-transitory computer-readable medium may include one or more of the following features. Instructions configured to cause the computer to receive the interference compensation data at the mobile device. The instructions configured to cause the computer to identify the notch filter configuration information using the transmission band information and the channel tuning information for compensating for the WWAN interference at the GNSS receiver further comprise instructions configured to cause the computer to identify the notch filter configuration information based at least in part on interference compensation data comprising a notch filter configuration information table and a notch filter configuration information index table associated with a band class in which the WWAN transceiver can be configured to operate. The instructions configured to cause the computer to identify the notch filter configuration information using the transmission band information and the channel tuning information further comprise instructions configured to cause the computer to: access an index value in the notch filter configuration information index table, the index value being associated with a channel information derived from the channel tuning information received from the WWAN transceiver; and access notch configuration data from the notch filter configuration information table using the index value from the notch filter configuration information index table. The instructions configured to cause the computer to dynamically configure the notch filters of the GNSS receiver according to the notch filter configuration information further comprise instructions configured to cause the computer to configure the notch filters of the using the notch configuration data from the notch filter configuration information table.

### BRIEF DESCRIPTION OF THE DRAWINGS

FIG. 1 is a block diagram of an example network architecture in which the techniques discussed herein can be implemented.

FIG. 2 is a block diagram of a mobile device that can be used to implement the mobile device illustrated in FIG. 1.

FIG. 3 is a flow diagram of a process that can be used to compensate for interference induced spurs in the GNSS signal data collected by a GNSS receiver of a mobile device.

FIG. 4 is a flow diagram of a process for capturing spur data using offline spectrum analysis.

FIG. 5 is a flow diagram of a process that can be used to generate compressed header data files from spur data files.

FIG. 6 is a flow diagram of a process that can be used to generate raw notch filter configuration information that can be used to implement part of the process illustrated in FIG. 5.

FIG. 7 is a process that can be used to generate a notch filter configuration information table and a notch filter configuration information index table that can be used by a mobile device 120 to dynamically configure notch filters for the GNSS receiver of the mobile device 120.

FIG. 8 is a process for compensating for interference in a GNSS receiver of a mobile device using notch filter configuration information identified in the interference compensation data generated by the process illustrated in FIG. 3.

FIG. 9 is an example of a raw notch filter configuration information table that can be generated using the techniques disclosed herein.

FIG. 10 is an example of a notch filter configuration information table that can be generated using the techniques disclosed herein.

FIG. 11 is an example of a notch filter configuration information index table that can be generated using the techniques disclosed herein.

FIG. 12 is an example of a computer system that can be used to implement the computer system used in the various techniques disclosed herein.

FIG. 13 is a functional block diagram of the computer system illustrated in FIG. 12 that illustrates functional modules of a memory shown in FIG. 12.

FIG. 14 is a functional block diagram of the mobile device illustrated in FIG. 2 that illustrates functional modules of a memory shown in FIG. 2.

FIG. 15 is an example of a raw spur data table.

FIG. 16 is a flow diagram of a process that can be used to identify notch filter configuration information.

### DETAILED DESCRIPTION

Techniques disclosed herein are configured to dynamically compensate for the impact of spurs in the GNSS band at the GNSS receiver in a timely fashion whenever the WWAN modem tunes to a different frequency band and/or channel or is configured to operate using a different wireless communication protocol. The techniques described herein are highly scalable with regard to the number of WWAN technologies, band classes, and/or channels supported by the WWAN modem and/or radio of the mobile device.

### Example Network Environment

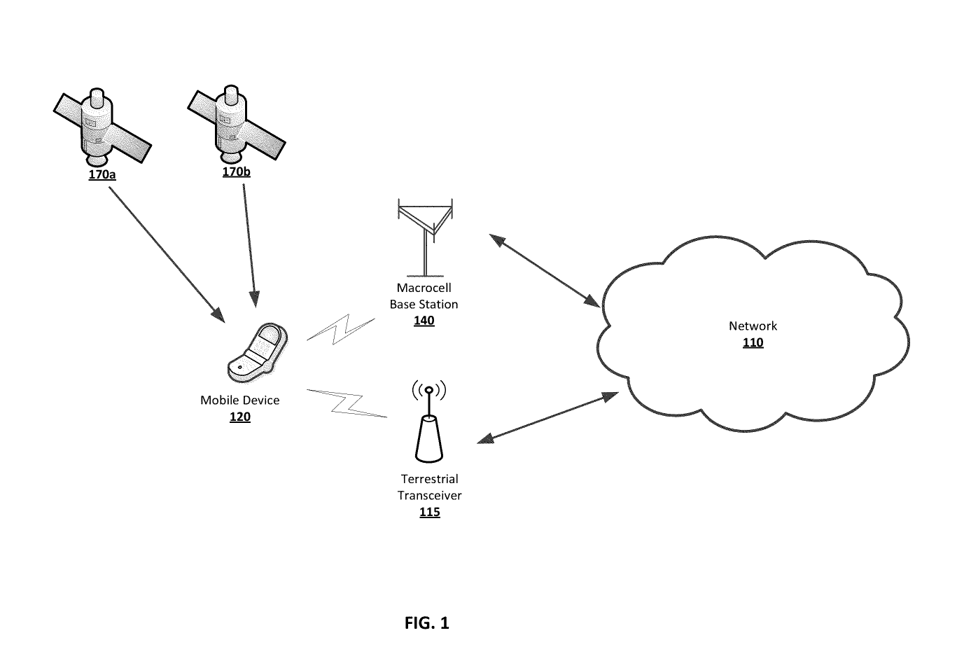

FIG. 1 is a block diagram of an example network architecture, which may be suitable for an implementing the techniques discussed herein. The particular configuration illustrated herein is merely an example of one network configuration in which the techniques disclosed herein may be used. Furthermore, an implementation of such a network architecture may include additional elements that are not illustrated herein and have been omitted for the sake of clarity.

The mobile device 120 can include a GNSS receiver that is configured to receive and measure signals from one or more satellites 170 and obtain pseudo-range measurements for the satellites. Satellites 170 may be part of a Global Navigation Satellite System (GNSS), which may be the United States Global Positioning System (GPS), the European Galileo system, the Russian GLONASS system, or some other GNSS. The GNSS receiver may also be configured to detect and receive signals from satellites 170 belonging to more than one GNSS system. For example, satellite 170a may belong to the GPS system while the satellite 170b might belong to the Galileo system. While the example network architecture illustrated herein illustrates only two satellites 170, other implementations may have more or less satellites available, and the number of satellites visible to the mobile device 120 may depend upon the current geographical location of the mobile devices and the orbits of the satellites 170.

The mobile device 120 may also measure signals from one or more wireless base stations, such as the terrestrial transceiver 115 and the macrocell base station 140, and obtain timing measurements (e.g., for time of arrival (TOA) or observed time difference of arrival (OTDOA)), signal strength measurements, and/or signal quality measurements for the wireless base stations. The pseudo-range measurements, timing measurements, signal strength measurements, and/or signal quality measurements may be used to derive a location estimate for the mobile device 120. A location estimate may also be referred to as a position estimate, a position fix, etc.

The mobile device 120 can also include a WWAN transceiver that can be used to send and/or receive data from one or more wireless base stations, such as terrestrial transceiver 115 and the macrocell base station 140. The inclusion of a terrestrial transceiver 115 and a macrocell base station 140 merely illustrates one possible configuration of a network architecture. Other configurations may include more include additional base stations and/or may not include both terrestrial transceivers and macrocell base stations.

The terrestrial transceiver 115 may comprise a femtocell, a picocell, a microcell, or other type of terrestrial transceiver 115. In some implementations, the terrestrial transceiver can comprise a WLAN wireless access point. Some terrestrial transceivers 115 may be associated with a WWAN network service provider and provide a means for extending the network coverage area provided by the WWAN network services provider. For example, femtocells, picocells, and microcells are typically associated with a WWAN service provider.

The terrestrial transceiver 115 can be configured to provide wireless network connectivity to one or more mobile devices, such as the mobile device 120. The terrestrial transceiver 115 can be associated with a mobile communication network provider and can be configured to communicate with the mobile communication network provider's network (not shown) via the network 110. The coverage area of the terrestrial transceiver 115 may overlap with that of one or more macrocell base stations, such as macrocell base station 140, or that of one or more other terrestrial transceivers (not shown). The terrestrial transceiver 115 can be connected to network 110 via a backhaul connection that provides a broadband connection to the network 110. The network 110 may be the Internet and/or a combination of one or more networks. For example, the terrestrial transceiver 115 may be connected to a DSL modem or a cable modem, depending upon the type of broadband service being used in that particular implementation.

Macrocell base station 140 can be configured to provide wireless network connectivity to a plurality of mobile devices 120. The macrocell base station 140 may be configured to provide a much larger coverage area than the terrestrial transceiver 115 or may be configured to provide a coverage area that is of a similar size or of a smaller size than the coverage are provided by the terrestrial transceiver 115. Macrocell base station 140 can be configured to communicate using one or more wireless communications protocols. While the example illustrated in FIG. 1 includes on a single macrocell base station 140, in other implementations, the terrestrial transceiver 115 may fall within the coverage area of multiple macrocell base stations 140, and the coverage area of the terrestrial transceiver 115 may overlap that of one or more other terrestrial transceivers.

The example network configuration illustrated in FIG. 1 is merely an example of one possible configuration of a network in which the techniques disclosed herein may be implemented. Other network configurations may include additional elements not illustrated in FIG. 1 and the various components may be interconnected in a different configuration than what is shown in FIG. 1.

### Example Hardware

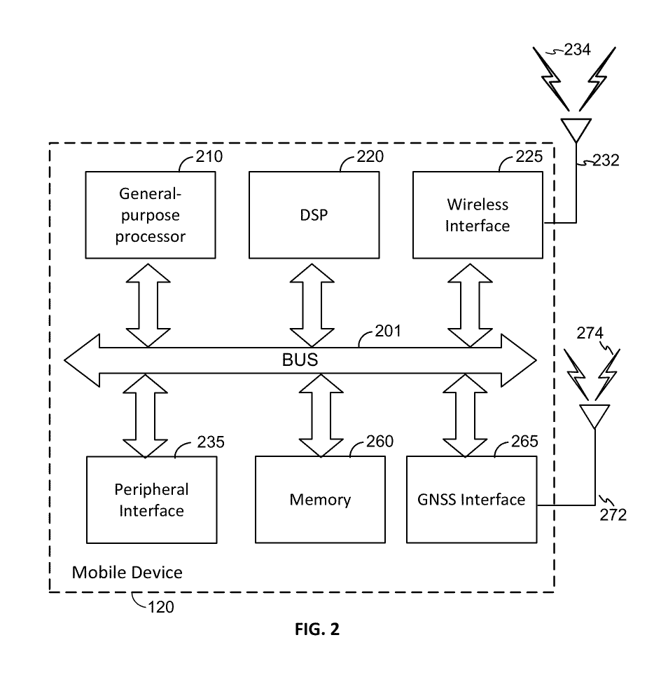

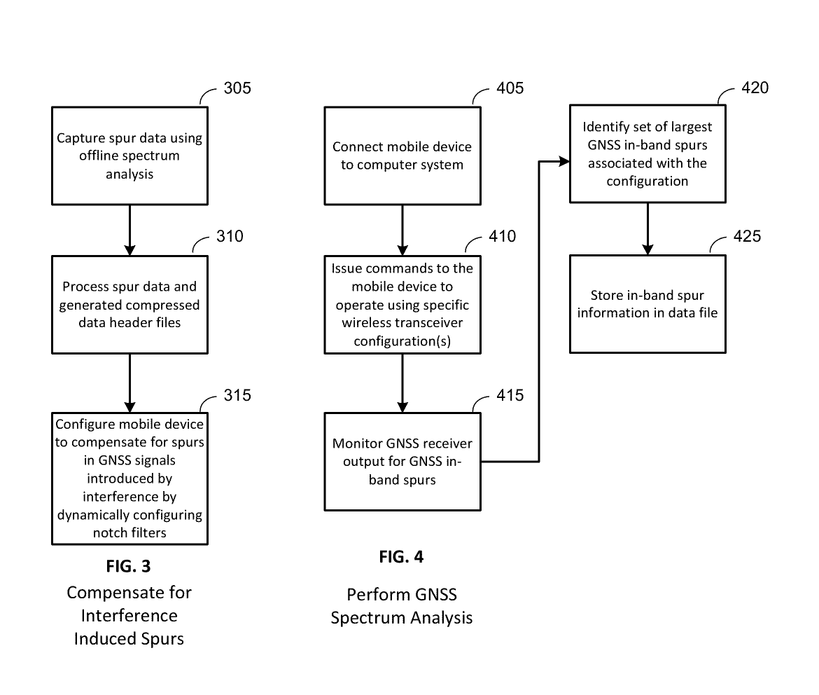

FIG. 2 is a block diagram of a mobile device that can be used to implement the mobile device 120 illustrated in FIG. 1. The mobile device 120 can be used to implement, at least in part, the processes illustrated in FIGS. 3-8.

The mobile device 120 comprises a computer system including a general-purpose processor 210, a digital signal processor (DSP) 220, a wireless interface 225, a peripheral interface 235, a GNSS interface 265, and a non-transitory memory 260, connected to each other by a bus 201.

The wireless interface 225 can comprise a multi-mode modem capable of transmitting and receiving wireless signals using multiple wireless communications standards. The wireless interface 225 can include a wireless receiver, transmitter, transceiver, and/or other elements that enable the mobile device 120 to send and/or receive data using the wireless communications protocols associated with WWAN, WLAN, and/or other types of wireless network. The wireless interface 225 is connected by a line 232 to an antenna 234 for sending and receiving communications to/from the terrestrial transceiver 115, the macrocell base station 140, and/or other wireless devices configured to communicate using wireless communication protocols.

The GNSS interface 265 can include a wireless receiver and/or other elements that enable the mobile device 120 to receive signals from transmitters associated with one or more GNSS systems. The GNSS interface 265 is connected by a line 272 to an antenna 274 for receiving signals from the GNSS transmitters. Mobile device 120 may include one or more transceivers configured to receive and/or send communications using other wireless protocols in addition to or instead of the transceivers illustrated in FIG. 2. DSP 220 can be configured to process signals received from the wireless interface 225 and/or the GNSS interface 265 and may be configured to process signals for or in conjunction with one or more modules implemented as processor-readable, processor-executable software code stored in memory 260 and/or may be configured process signals in conjunction with the processor 210.

The processor 210 can be an intelligent device, e.g., a personal computer central processing unit (CPU) such as those made by Intel® Corporation or AMD®, a microcontroller, an application specific integrated circuit (ASIC), etc. The memory 260 is a non-transitory storage device that can include random access memory (RAM), read-only memory (ROM), or a combination thereof. The memory 260 can store processor-readable, processor-executable software code containing instructions for controlling the processor 210 to perform functions described herein (although the description may read that the software performs the function(s)). The software can be loaded onto the memory 260 by being downloaded via a network connection, uploaded from a disk, etc. Further, the software may not be directly executable, e.g., requiring compiling before execution.

The software in the memory 260 is configured to enable the processor 210 to perform various actions, including implementing sending and/or receiving data from the terrestrial transceiver 115, the macrocell base station 140, other mobile devices 120, and/or other devices configured for wireless communication. The software in the memory 260 can also be configured to allow the mobile device 120 to compensate for interference introduced at the GNSS interface 265 by the transmitter of the wireless interface 225.

The peripheral interface 235 can be configured to allow the mobile device 120 to be connected to one or more peripheral devices, such as the computer system 1200, an external data storage device, or a power supply for charging a battery of the mobile device 120. The peripheral interface 235 can be configured to provide wired and/or wireless connectivity between the mobile device 120 and the one or more peripheral devices. For example, the peripheral interface 235 can be configured to wirelessly send data to and/or receive data from one or more peripheral devices using one or more other wireless protocols, such as Bluetooth, Near Field Communication (NFC), and/or other wireless communications protocols. The peripheral interface 225 may be configured to send data to and/or receive data from one or more peripheral devices over a wired connection using one or more other wireless protocols, such as a universal serial bus (USB) connection, a FireWire connection, and/or other wired communication protocols.

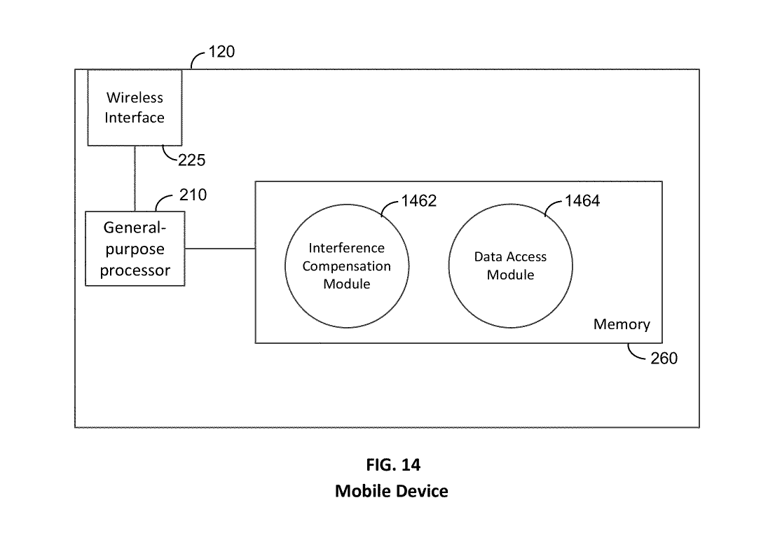

FIG. 14 is a functional block diagram of the mobile device 120 illustrated in FIG. 2 that illustrates functional modules of the memory 260 shown in FIG. 2. For example, the mobile device 120 can include an interference compensation module 1462 and a data access module 1464. The mobile device 120 may also include one or more additional functional modules that provide other functionality to the mobile device 120. The mobile device 120 illustrated in FIGS. 2 and 14 can be used to implement the mobile device 120 associated with the processes illustrated in FIGS. 3-8.

The interference compensation module 1462 can be configured to determine band class and channel information associated with an operating state of the wireless interface 225 and to use that information to dynamically configure notch filters for the GNSS receiver of the GNSS interface 265. The wireless interface 225 can be configured to provide band class and channel information to the mobile device 120 each time that a transceiver or transmitter of the wireless interface 225 is configured to operate using a new channel and/or frequency band. For example, the wireless interface 225 can be configured to transmit and/or receive data using different wireless communications protocols and using different band classes and/or channels and may switch between band classes and/or channels based network availability and/or channel conditions. The wireless interface 225 can provide a signal to the interference compensation module 1462 in the event of such a change, so that the interference compensation module 1462 dynamically configure notch filters of the GNSS receiver to compensate for interference associated with the transmitter or transceiver of the wireless interface 225 when operating using the newly selected band class and/or channel.

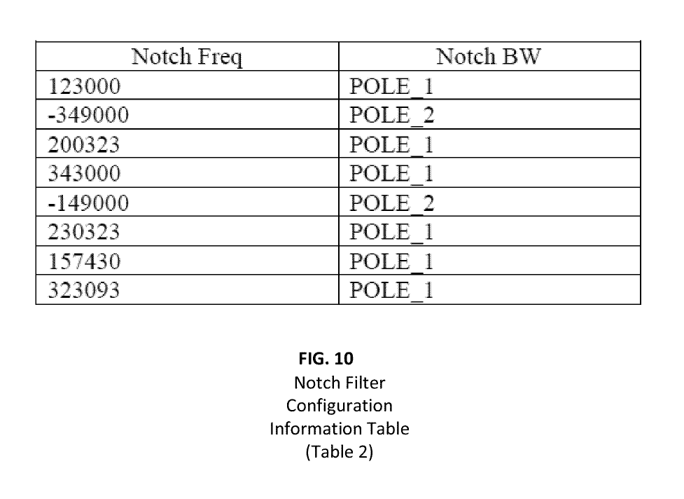

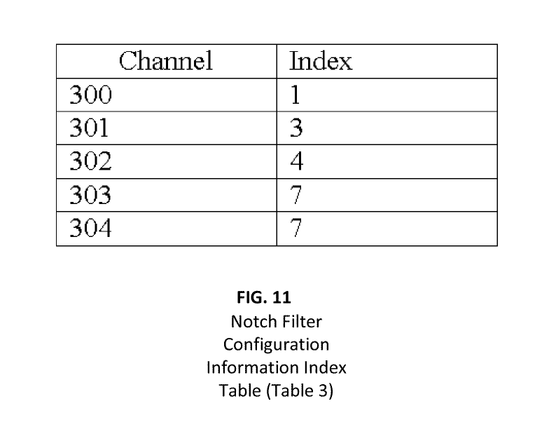

The interference compensation module 1462 can be configured to identify notch filter configuration information using the transmission band information and the channel tuning information for compensating for WWAN interference at the GNSS receiver. The interference compensation module 1462 can be configured to access interference compensation data using the transmission band information and the channel tuning information provided by the wireless interface 225 and to use the interference compensation information to identify notch filter configuration information that can be used to dynamically configure the notch filters of the GNSS receiver of the GNSS interface 265. The interference compensation module 1462 can be configured to access the interference compensation data by sending a request to the data access module 1464. The interference compensation data can be stored in the form of compressed header data files in some implementations. The interference compensation data can be stored in the memory 260 and/or another data storage device associated with the mobile device 120. The interference compensation data may be stored organized in the form of one or more notch filter configuration information tables and notch filter configuration information index tables, such as those illustrated in FIGS. 10 and 11. The notch filter configuration information may include one or more notch filter configuration settings associated with the band class and/or channel. In some instances, a particular band class and/or channel may not have any associated notch filter configuration information. This can occur when no out of specification spur data was detected during when testing the transceiver of the wireless interface 225 operating at that particular band class and/or channel.

The data access module 1464 can be configured to store data in the memory 260 and/or other data storage devices associated with the mobile device 120. The data access module 1464 can also be configured to access data in the memory 260 and/or other data storage devices associated with the mobile device 120. The data access module 1464 can be configured to receive requests from other modules and/or components of the mobile device 120 and to store and/or access data stored in the memory 260 and/or other data storage devices associated with the mobile device 120.

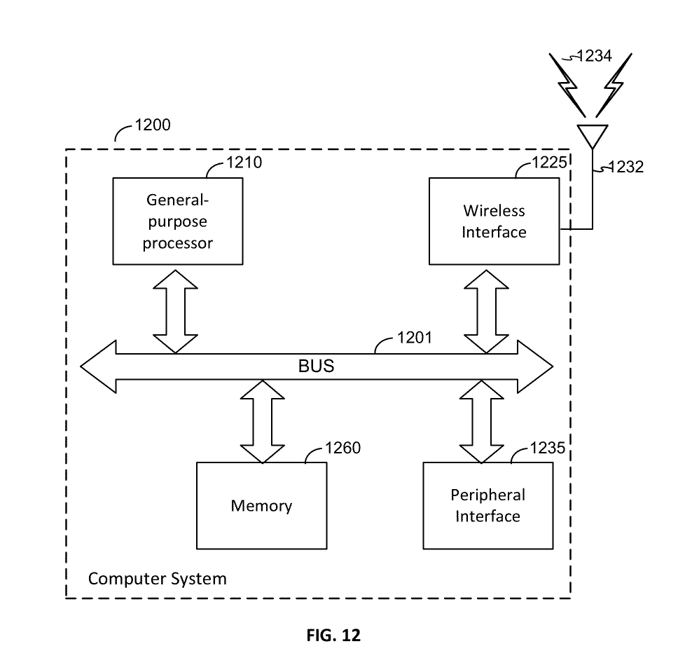

FIG. 12 is a block diagram of a computer system that can be used to implement at least in part, the processes illustrated in FIGS. 3-8 associated with a computer system.

The computer system 1200 comprises a general-purpose processor 1210, a wireless interface 1225, a peripheral interface 1235, and a non-transitory memory 1260, connected to each other by a bus 1201. The wireless interface 1225 can include a wireless receiver, transmitter, transceiver, and/or other elements that enable the computer system 1200 to send and/or receive data via WWAN and/or WLAN networks. The wireless interface 1225 is connected by a line 1232 to an antenna 1234 for sending and receiving wireless communications. In other implementations, the computer system 1200 can include a wired interface (not shown) that can provide wired network connectivity to one or more networks.

The peripheral interface 1235 can be configured to allow the computer system 1200 to be connected to one or more peripheral devices. For example, the peripheral interface 1235 can be configured allow the mobile device 120 to be connected to the computer system 1200 to allow the computer system 1200 to conduct spectrum analysis with the transmitter or transceiver of wireless interface 225 of the mobile device 120 by configuring the wireless interface 225 to operate using various band classes and/or channels. The peripheral interface 1235 can provide wired and/or wireless connectivity between the computer system 1200 and peripheral devices. For example, the peripheral interface can be configured to wirelessly send data to and/or receive data from one or more peripheral devices using one or more other wireless protocols, such as Bluetooth, Near Field Communication (NFC), and/or other wireless communications protocols. The peripheral interface may be configured to send data to and/or receive data from one or more peripheral devices over a wired connection using one or more other wireless protocols, such as a universal serial bus (USB) connection, a FireWire connection, and/or other wired communication protocols.

The processor 1210 can be an intelligent device, e.g., a personal computer central processing unit (CPU) such as those made by Intel® Corporation or AMD®, a microcontroller, an application specific integrated circuit (ASIC), etc. The memory 1260 is a non-transitory storage device that can include random access memory (RAM), read-only memory (ROM), or a combination thereof. The memory 1260 can store processor-readable, processor-executable software code containing instructions for controlling the processor 1210 to perform functions described herein (although the description may read that the software performs the function(s)). The software can be loaded onto the memory 1260 by being downloaded via a network connection, uploaded from a disk, etc. Further, the software may not be directly executable, e.g., requiring compiling before execution.

The software in the memory 1260 is configured to enable the processor 1210 to perform various actions, including interfacing with the mobile device 120 to capture spur data produced using spectrum analysis techniques. The software in the memory 1260 can also be configured to generate interference compensation data that can be used by the mobile device 120 to identify notch filter configuration information that can be used to dynamically configure the notch filters of the GNSS receiver of the GNSS interface 265. The interference compensation data can be formatted in the form of compressed header data files in some implementations. The interference compensation data can be stored in the memory 1260 and/or another data storage device associated with the computer system 1200. The software can be configured to transfer the interference compensation data to the mobile device 120. The interference compensation data may be stored organized in the form of one or more notch filter configuration information tables and notch filter configuration information index tables, such as those illustrated in FIGS. 10 and 11.

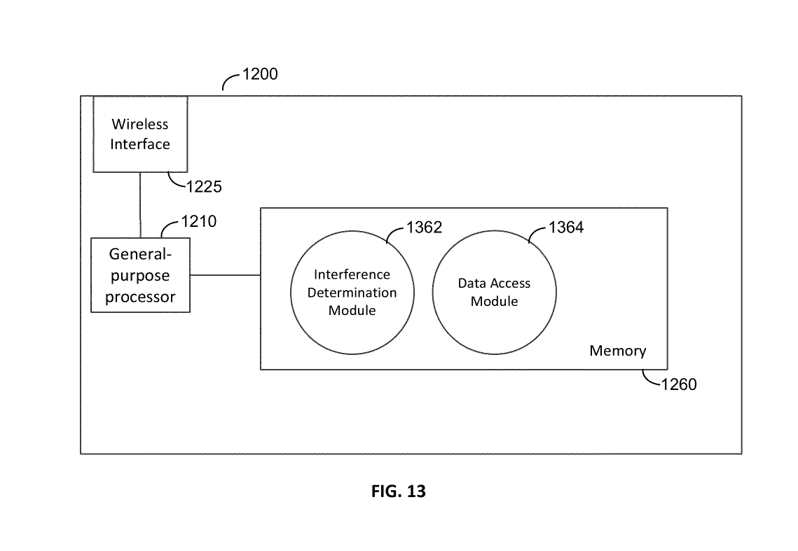

FIG. 13 is a functional block diagram of the computer system 1200 illustrated in FIG. 12 that illustrates functional modules of a memory 1260 shown in FIG. 12. For example, the computer system 1200 can include an interference determination module 1362 and a data access module 1364. The computer system 1200 may also include one or more additional functional modules that provide other functionality to the computer system 1200. The computer system 1200 illustrated in FIGS. 12 and 13 can be used to implement the computer system 1200 associated with the processes illustrated in FIGS. 3-8.

The interference determination module 1362 can be configured to generate interference compensation information that can be used by the mobile device 120 that can be used to dynamically configure the notch filters of the GNSS receiver of the GNSS interface 265. The interference compensation data can be formatted form of compressed header data files in some implementations and may be stored in the memory 1260 and/or another data storage device associated with the computer system 1200. The interference compensation data may be organized in the form of one or more notch filter configuration information tables and notch filter configuration information index tables, such as those illustrated in FIGS. 10 and 11. The interference determination module 1362 and/or the data access module 1364 can be configured to provide a copy of the interference compensation data to the mobile device 120. For example, the interference determination module 1362 and/or the data access module 1364 can be configured to send the interference compensation data to the mobile device 120 via the peripheral interface 1235 and/or the wireless interface 1225.

The data access module 1364 can be configured to store data in the memory 1260 and/or other data storage devices associated with the computer system 1200. The data access module 1364 can also be configured to access data in the memory 1260 and/or other data storage devices associated with the computer system 1200. The data access module 1364 can be configured to receive requests from other modules and/or components of the computer system 1200 and to store and/or access data stored in the memory 1260 and/or other data storage devices associated with the computer system 1200.

### Example Implementations

FIG. 3 is a flow diagram of a process that can be used to compensate for interference induced spurs in GNSS signal data collected by a GNSS receiver of a mobile device 120. The process illustrated in FIG. 3 can be implemented in by the computer system 1200 illustrated in FIGS. 12 and 13 in conjunction with the mobile device 120 illustrated in FIGS. 2 and 14. In some implementations, the process illustrated in FIG. 3 may be used to compensate for interference induced spurs in the GNSS signal data collected by a GNSS receiver of a wireless access point, terrestrial transceiver, or other device that includes a GNSS receiver and a WWAN transceiver or other wireless transceiver that may introduce interference into the GNSS signals. Furthermore, while the processes discussed herein are described with regard to mobile device, such as a mobile phone or tablet computer, the processes herein may also be used by other types of devices that may include a GNSS receiver and a wireless transceiver, such as a wireless access point or a base station. While the example illustrated in FIG. 3 describes the process illustrated in FIG. 3 as being implemented on a separate computer system 1200 than the mobile device 120, in some alternative implementations, the mobile device 120 can include sufficient resource, such as processor power and memory resources, to implement the process illustrated FIG. 3 on the mobile device 120 and/or the processes illustrated in FIG. 4-7 that are otherwise described herein as being implemented on the computer system 1200 or other computer system separate from the mobile device 120.

The process begins with capturing spur data using offline spectrum analysis (stage 305). In this stage, the WWAN transceiver or other wireless transceiver of the wireless interface 225 mobile device 120 can be configured to operate under various conditions to capture in-band spur information for the various operating conditions. The offline spectrum analysis can produce very large (e.g., multiple-megabyte sized) files that contain in-band spur information. FIG. 4 illustrates an example of a process that can be used to implement stage 305 of the process illustrated in FIG. 3. For example, the wireless interface 225 of the mobile device can be configurable to operate multiple wireless communications protocols, and each wireless communication protocol can be associated with one or more frequency band classes, which in turn may be associated with a range of channel numbers. In stage 305, the mobile device 120 can be connected to the computer system 1200 which can be configured to control the operation of the wireless transceiver of the wireless interface 225 of the mobile device 120. For example, the mobile device 120 can be connected to the computer system 1200 via the peripheral interface 1235.

The computer system 1200 can be configured to operate the wireless transceiver 225 of the mobile device 120 in a series of band class and/or channel configurations when conducting the offline spectrum analysis. For each configuration being tested, the computer system 1200 can be configured to collect data from the receiver of the GNSS interface 265 of the mobile device 120 as the wireless transceiver of the wireless interface 225 is transmitting. In some implementations, the computer system 1200 can be configured to operate the wireless transceiver 225 of the mobile device 120 in a series of regular transmission waveforms during a full-rate data call for a particular WWAN technology. The computer system 1200 can be configured to operate the wireless transceiver 225 of the mobile device 120 operate the wireless transceiver 225 of the mobile device 120 in a series of regular transmission waveforms during a full-rate data call for a series of wireless communication protocols supported by the mobile device 120.

Certain configurations of the wireless transceiver of the wireless interface 225 may produce interference at the receiver of the GNSS interface 265, which can appear as spurs in the data collected from the GNSS receiver. The data collected can be time stamped and/or otherwise marked so that the data can later be interpreted to determine which configurations of the wireless transceiver of the wireless interface 225 was being tested as the data was collected. As indicated above, the spectrum analysis process may produce very large files that would not be suitable for use for dynamically configuring notch filters of the GNSS receiver of the GNSS interface 265 due the large size of the files. However, the raw data files can be processed to reduce the amount of data into a size that can be used by the mobile device 120 to dynamically configure the notch filters of the GNSS receiver. Examples of processes that can be used to process the raw data files are disclosed herein.

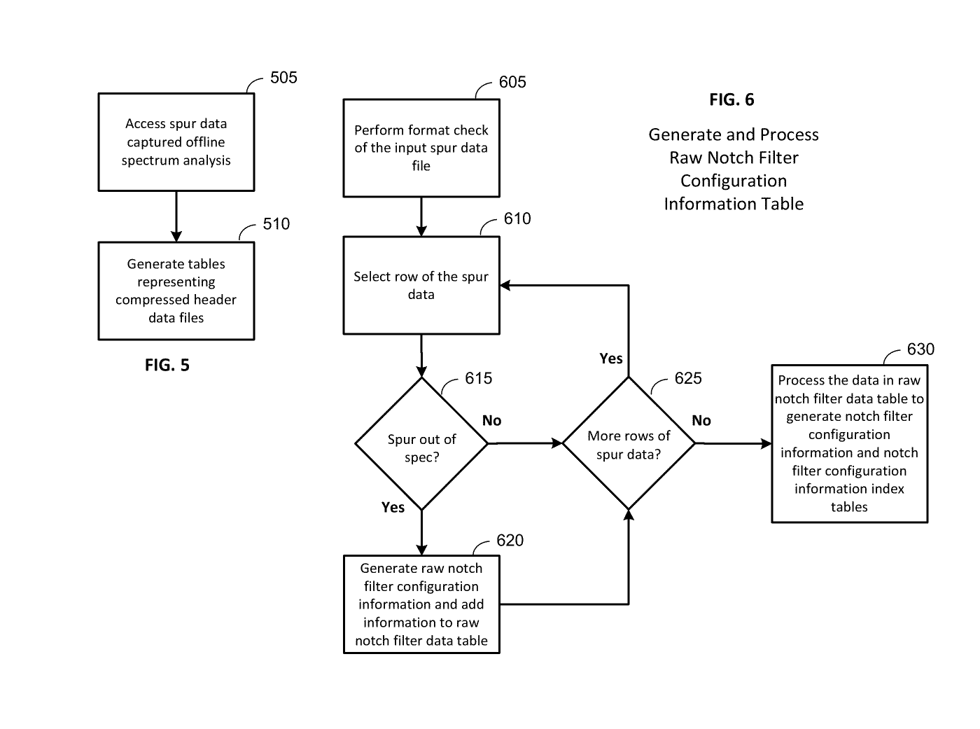

The process can continue with processing the spur data generated in stage 310 to generate compressed data header files, which are also referred to herein as interference compensation data (stage 310). The interference determination module 1362 of the computer system 1200 can be configured to perform this processing. As indicated above, the spur data files generated in stage 310 can be very large. Processing such large files in real time on a mobile device would require substantial processor and/or memory resources. The data in these files can be compressed and reorganized into a format that the mobile device 120 can use to dynamically compensate for interference at the GNSS receiver. For example, in some implementations, the compressed header data files can comprise a notch filter configuration information table and a notch filter configuration information index table associated with each band class that the wireless transceiver 225 of the mobile device 120 can be configured to operate in and for which data was captured in stage 305. An example of a notch filter configuration information table is provided as Table 2 in FIG. 10, and an example of a notch filter configuration information index table is provided as Table 3 in FIG. 11. The contents of these tables are described in greater detail below with respect to the processes illustrated in FIGS. 5-7, which can be used to implement stage 310.

The process of FIG. 3 can continue with configuring the mobile device 120 to compensate for spurs introduced in GNSS signals received at the GNSS receiver of the mobile device 120 by dynamically configuring notch filters to compensate for the spurs (stage 315). The compressed data header files generated in stage 310 can be copied to the mobile device 120. For example, the compressed data header files can be copied to memory 260 of the mobile device or another persistent memory associated with the mobile device 120, and the mobile device 120 can be configured to access the compressed data header files. In some implementations, the compressed data header files can be stored on a network entity accessible to the mobile device 120, and the mobile device 120 can be configured to request the compressed header data files from the network entity. For example, the network entity can comprise one or more servers associated with a network service provider that is also associated with the mobile device 120. In other implementations the network entity can comprise one or more servers associated with a manufacturer of the mobile device 120. In other implementations, the network entity may be configured to push the compressed header data files to the mobile device 120. For example, the compressed header data files may be included with content pushed to the mobile device 120 from the network service provider periodically, upon registering the mobile device 120 with the network provided by the mobile service provider, at predetermined intervals, or at other times as determined by the network service provider.

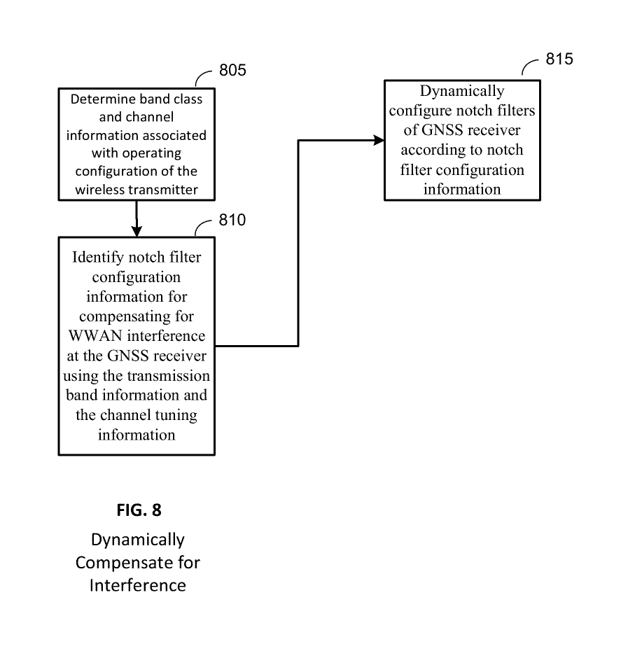

The mobile device 120 can be configured to use the compressed data header files generated in stage 310 to determine notch filter configuration information that can be used to dynamically configure the notch filters. For example, the mobile device 120 can include software that is configured to monitor the band class and/or channel configuration of the transceiver of the wireless interface 225 and that can dynamically configure the notch filter settings of the receiver of the GNSS interface 265 based on the band class and/or channel configuration of the transceiver of the wireless interface 225 using the compressed data header files. FIG. 8 provides an example process in which the mobile device 120 uses the compressed header data files to dynamically configure the notch filters of the GNSS receiver of the GNSS interface 265.

FIG. 4 is a flow diagram of a process for capturing spur data using offline spectrum analysis. The process illustrated in FIG. 4 can be used to implement stage 305 of the process illustrated in FIG. 3. The process illustrated FIG. 4 can be implemented using the computer system 1200 and the mobile device 120. The interference compensation module 1462 of the computer system 1200 can be configured to perform the actions associated with the computer system 1200 of the process illustrated in FIG. 4.

The process illustrated in FIG. 4 can be performed by connecting the mobile device 120 to the computer system 1200 (stage 405). The mobile device 120 may be connected to the computer system 1200 via a wired or a wireless connection via the peripheral interface 1235 of the computer system 1200 and the peripheral interface 235 of the mobile device. In some implementations, the interference determination module 1362 of the computer system 1200 can be configured to detect that the mobile device 120 has been connected to the computer system 1200 and provide an indication to the user of the computer system 1200 that the mobile device 120 has been detected and that the computer system 1200 is ready to conduct the offline spectrum analysis. In implementations where the mobile device 120 is includes sufficient resources to perform the offline spectrum analysis onboard the mobile device 120, stage 405 would not be necessary and the process can begin with initiating software or an application on the mobile device 120 to conduct the offline spectrum analysis.

One or more test commands can be issued to the mobile device 120 to operate using specific wireless transceiver configurations (stage 410). A test command can comprise instructions configured to cause the wireless transceiver of the wireless interface 225 of the mobile device to transmit on a specified band class and/or channel. A test command may also specify data to be transmitted by the mobile device. For example, a test command may include information identifying a predetermined data pattern to be transmitted by the wireless transceiver of the mobile device 120 for testing interference effects at the GNSS receiver of the mobile device 120.

In some implementations, the interface determination module 1362 can be configured to provide a user interface that allows a user of the computer system 1200 to select the configuration or configurations of the wireless transceiver of the wireless interface 225 of the mobile device are to be tested. For example, the interference determination module 1362 can be configured to determine which band classes and/or channels that the wireless transceiver 225 of the mobile device 120 can be configured to operate with and can provide a list of those configurations to a user of the computer system 1200. In other implementations, the interference determination module 1362 can be configured to receive input from the user that identifies the type of mobile device 120 connected to the computer system 1200, and the interference determination module 1362 can be configured to access a wireless device information in memory 1260 or another data store associated with the mobile device.

The output of the GNSS receiver of the mobile device 120 can be monitored for GNSS in-band spurs (stage 415). The computer system 1200 can be configured to receive an output signal from the GNSS receiver of the GNSS interface 265 of the mobile device 120. The signal data can be provided by the mobile device 120 to the computer system 1200 via the peripheral interface 235. The computer system 1200 can be configured to store the signal data from the GNSS receiver in memory 260 and/or another memory associated with the mobile device. The interference determination module 1362 can be configured to identify in-band spurs in the GNSS receiver signal data that occurred during the testing. In some implementations, the interference determination module 1362 can be configured to identify any in-band spurs that exceed a predetermined threshold as candidates for mitigation using a notch filter at the GNSS receiver of the mobile device 120.

The computer system 1200 can be configured to identify a set of largest GNSS in-band spurs associated with the configuration being tested (stage 420) and to store the in-band spur information can be stored in one or more data file (stage 425). The interference determination module 1362 can be configure to identify GNSS in-band spurs and the power and frequency of the spurs can be stored in a spreadsheet or other data file in memory 1260 and/or another memory associated with the computer system. The number of in-band spurs to be included for each channel may vary in different implementations. For example, the GNSS receiver of one mobile device 120 may be configurable to support more notch filters than the GNSS receiver of another mobile device 120, and the number of GNSS in-band spurs selected for process can be configured based on the mobile device 120 being tested. In other implementations, the computer system 1200 can be configured to select a predetermined number of largest GNSS in-band spurs without customizing the number of in-band spurs selected based on the mobile device 120 being tested.

The process illustrated in FIG. 4 can be repeated for all band and channels associated with each wireless technology that the wireless transceiver of the wireless interface 225 of the mobile device 120 is configured to support. The resulting data files can be extremely huge, in the order of tens to hundreds of megabytes of data. The stage 310 of the process illustrated in FIG. 3 can be used to compresses the data files to reduce the storage and processing requirements needed to process these files.

FIG. 5 is a flow diagram of a process that can be used to generate compressed header data files from spur data files generated during the offline spectrum analysis performed in stage 305 of FIG. 3 and also discussed above in FIG. 4. The process illustrated in FIG. 5 can be used to implement stage 310 of the process illustrated in FIG. 3. The process illustrated in FIG. 5 can be implemented on the computer system 1200 illustrated in FIG. 12. The interference determination module 1362 of the computer system 1200 can be configured to perform the process illustrated in FIG. 5.

The process can begin with accessing spur data generated in stage 305 of the process illustrated in FIG. 3 (stage 505). The interference determination module 1362 can be configured to request one or more spur data files from the data access module 1364. The data access module 1364 can be configured to access the spur data files in the memory 1260, and to provide the spur data files to the interference determination module 1362 for processing.

The spur data can be analyzed to generate compressed header data files (also referred to herein as “interference compensation data”) that can be used by the mobile device 120 to identify notch filter configuration information that can be used to dynamically configure notch filters of the GNSS receiver of the GNSS interface 265 to compensate for interference at the GNSS receiver that is introduced by operation of the wireless transceiver of the mobile device 120 (stage 510). The interference determination module 1362 of the computer system 1200 can be configured to generate the compressed header data files from the raw spur data collected during the testing of the mobile device in stage 305 of the process illustrated in FIG. 3. FIG. 6 illustrates an example process that can be used to generate the compressed header files that can be used by the mobile device 120.

In one implementation, interference determination module 1362 of the computer system 1200 can be configured such that the raw spur data files may contain up to ten of the largest spurs detected for each band/channel combination supported by the wireless transceiver of wireless interface 225 the mobile device 120. In other implementations, the interference determination module 1362 can be configured to store up to a different maximum number of largest spurs for each band/channel combination. In some implementations, the interference determination module 1362 can be configured to generate up to six notch filter settings for a particular band class and/or channel based on the ten largest spurs collected for that particular band class and/or channel. The maximum number of notch filters that can be generated for each band/channel combination is referred to herein as the maximum filter count. The maximum filter can vary in different implementations. In some implementations, the maximum filter count can vary from mobile device to mobile device 120 based on the type and/or configuration of the wireless transceiver of the wireless interface 225 the mobile device 120 and/or the type and/or configuration of the GNSS receiver of the mobile device 120. The interference determination module 1362 can be configured to select an appropriate maximum filter count for the mobile device 120 being tested or can also be configured to provide a user interface that allows a user of the computer system 1200 to define the maximum filter count to be used for the mobile device 120.

If the notch filter data were stored for all bands/channels for all of the wireless technologies that the wireless transceiver of the mobile device 120 is capable of supporting, the data would be likely to require an excessive amount of memory space in the memory of the mobile device 120. Furthermore, the number of notch filter settings that may be needed for a particular band/channel combination may be an arbitrary number from zero to the maximum filter count. Accordingly, the process of generating the compressed header data files can be configured to only store those notches that would actually be used for a particular band/channel in the header file to conserve memory and processor resources.

FIG. 6 is a flow diagram of a process that can be used to generate raw notch filter configuration information that can be used to derive notch filter configuration data that can be used to dynamically configure the notch filters of the GNSS receiver of the mobile device 120. The process illustrated in FIG. 6 can be used to implement a portion of stage 510 of the process of FIG. 5. The process illustrated in FIG. 6 may be implemented on a computer system that has sufficient processor and memory resources to handle processing of the large spur data files generated in stage 305 of the process illustrated in FIG. 3. The process illustrated in FIG. 6 can be implemented on the computer system 1200 illustrated in FIG. 12. For example, the interference determination module 1362 of the computer system 1200 can be configured to perform the stages of FIG. 6.

The process illustrated in FIG. 6 can begin with an optional format check of the input spur data file generated in stage 305 of the process illustrated in FIG. 3. For example, the interference determination module 1362 of the computer system 1200 can be configured to check the format of the spur data files generated in stage 305. If the format of the file is not correct or is corrupted, the process can be configured to stop processing the file and to issue an alert to a user that the file format is not what was expected or that the data is corrupted. In some implementations, stage 305 of the process illustrated in FIG. 3 may have generated multiple spur data files, and the format of each of the spur data files can be verified.

The process can continue with selecting a row of the spur data from the spur data file (or from one of the multiple spur data files) that has not yet been processed (stage 605). As discussed above, the spur data files may include data for multiple spurs for each band/channel combination supported by the wireless transceiver of wireless interface 225 the mobile device 120. A determination can then be made whether the spur data in the selected row of the spur data file does not satisfy one or more predetermined specifications (stage 615). For example, a determination can be made whether the spur exceeds a predetermined threshold.

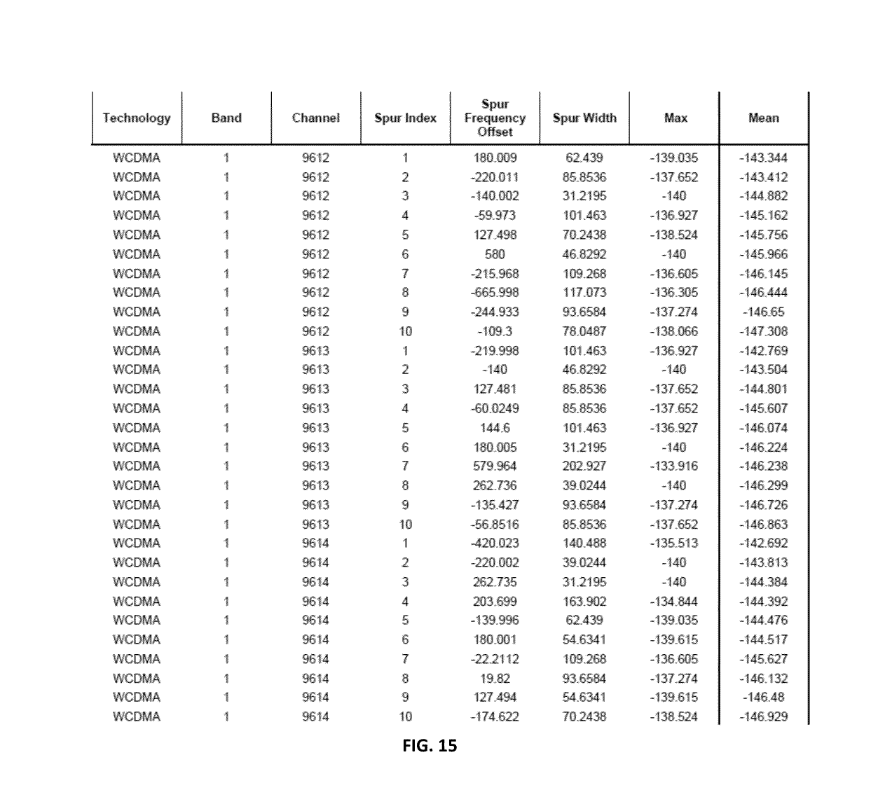

FIG. 15 provides an example raw spur data table that illustrates an example of determining whether a spur should be marked as out of specification. In the example illustrated in FIG. 15, the “technology” column represents the wireless technology being tested, which in this example is WCDMA. The “Band” column represents the frequency band that was tested and “Channel” represents the channel associated with the frequency band that was tested. The “Spur Index” column associates an index value with each row of spur data that has been added to the raw spur data table. In the example illustrated in FIG. 15, the table includes up to 10 of the largest spurs associated with each channel. In other implementations, the number of largest spurs stored for each of the channels may vary. The spur frequency offset column represents an offset of the spur from the frequency associated with the channel. The unit of measurement for the “max” and the “mean” columns is dBm, which represents the power ratio in decibels of the measured power reference to one milliwatt. The value in the “max” column represents a maximum allowed spur power level in dBm based on the spur bandwidth (BW), and the value in the “mean” column represents the mean measured spur power level.

One example technique that can be used to determine whether a peak is out of specification and should be notched out is to compare the max and mean values associated with that peak. For example, in one implementation, if the mean is greater than or equal to the max value minus 5 (i.e., MEAN (MAX−5)), then the spur is out of specification and a notch filter setting can be generated for that channel and spur frequency. Any spur within 5 dB of the spur specification can be identified using this technique. This example provides one example for determining whether a particular spur in the raw spur data table is out of specification. In other implementations, a different technique may be used to identify whether a particular spur is out of specification. Furthermore, the 5 dB value used in the calculation used in this example provides a 5 dB margin for capturing spurs that are close to the maximum allowed spur power level. A different margin that is larger than or smaller than the 5 dB example illustrated in this example implementation can be used in other implementations.

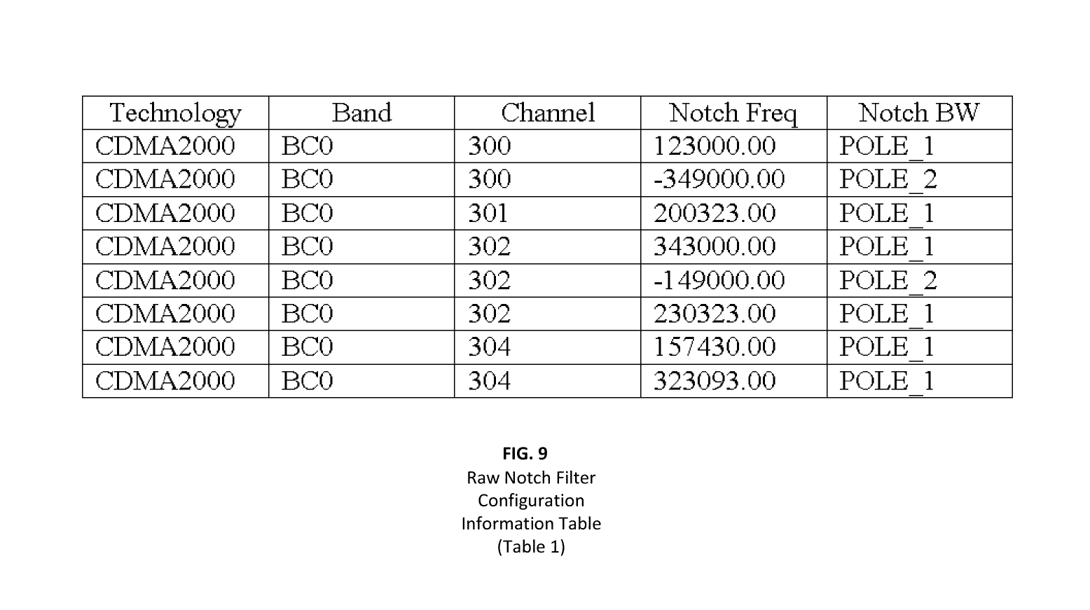

If the spur associated with the selected row of spur data does not satisfy the one or more predetermined specifications, then raw notch filter configuration information for the spur can be generated and the information added to a raw notch filter configuration information table (stage 620). An example of such a table is illustrated in Table 1 of FIG. 9. In the example implementation, illustrated in FIG. 9, the raw notch filter configuration information included in each row of the raw notch filter configuration information table includes fields for: (1) a technology that the wireless transceiver of the wireless interface 225 the mobile device 120 was configured to operate using when the spur data was captured; (2) a band class that the wireless transceiver was configured to operate using when the spur data was captured; (3) a channel from the band class that the wireless transceiver was configured to operate using when the spur data was captured; (4) a notch center frequency associated with the spur (the frequency at which the spur caused by the interference was present in the GNSS data); and (5) notch bandwidth (BW) which indicates how wide the notch filter will be configured to be. The width of the notch filter can be configured based on the frequency range of the spur to be notched out. The example Table 1 illustrated in FIG. 9 includes data for a single technology (CDMA200) and a single band class (BC0), but other implementations may include data from other technologies and/or band classes and may include multiple technologies and/or band classes. The content of Table 1 is dependent upon the various configurations supported by the wireless transceiver of the wireless interface 225 the mobile device 120 and can vary from mobile device 120 to mobile device 120. The process can then continue from stage 620 to stage 625.

Returning now to the process illustrated in FIG. 6, if the spur associated with the selected row of raw spur data did satisfy the one or more predetermined specifications, then it is not necessary to compensate for the interference associated with that spur, the spur data does not need to be inserted into the raw notch filter configuration information table, and the process can continue with stage 625. At stage 625, a determination is made whether there are more rows from the spur data file to be processed and/or whether additional spur data files remain to be processed. If additional rows of data remain to be processed, the process can continue with stage 610. Otherwise, if no additional rows of data remain to be processed, the process can continue with stage 630. At stage 630, the data in the raw notch filter configuration information table can be processed to generate a notch filter configuration information table and a notch filter configuration information index table that can be used by the mobile device 120 to dynamically configure the notch filters based on the configuration of the wireless transceiver of the wireless interface 225 the mobile device 120.

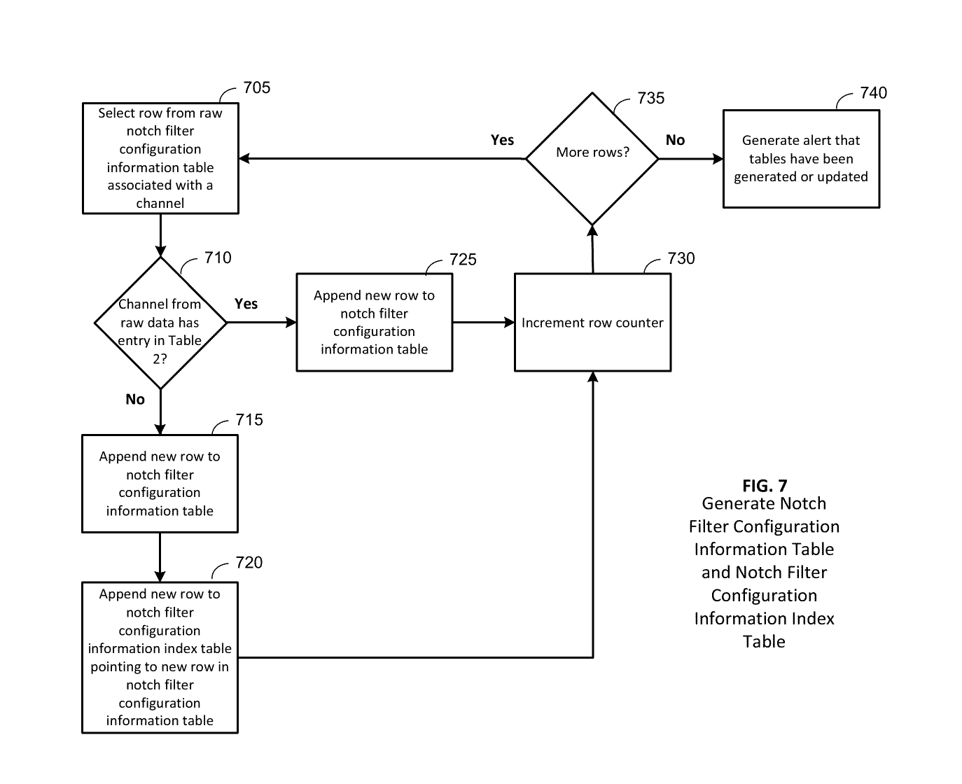

FIG. 7 is a process that can be used to generate a notch filter configuration information table and a notch filter configuration information index table that can be used by a mobile device 120 to dynamically configure notch filters for the GNSS receiver of the mobile device 120. The process illustrated in FIG. 7 can be used to implement a portion of stage 630 of the process of FIG. 6 and can be used to generate the notch filter configuration information table and the notch filter configuration information index table that can be used by a mobile device 120 to dynamically configure the notch filters based on the configuration of the WWAN processor of the mobile device 120. The process illustrated in FIG. 7 can be implemented on the computer system 1200 illustrated in FIG. 12. For example, the interference determination module 1362 of the computer system 1200 can be configured to perform the stages of FIG. 7.

The process can begin with selecting a row of raw notch filter configuration information from the raw notch filter configuration information table generated in the process illustrated in FIG. 6 (stage 705). An example of such a table is provided as Table 1 of FIG. 9. A determination can then be made whether the channel associated with the selected row of data from the raw notch filter configuration information table has any entries associated with it in the notch filter configuration information table (Table 2) (stage 710). An example of the notch filter configuration information table is provided as Table 2 in FIG. 10, and an example of the notch filter configuration information index table is provided as Table 3 in FIG. 11. The notch filter configuration information table can be configured to store the notch filter configuration information for a particular band class (BC) together. The table can be configured to store a minimal amount of information needed to program the notches for every channel in a band class. The notch filter configuration information index table (Table 3) serves as an index to the notch filter configuration information table and can be configured to store each of the channel numbers associated with a band class and an index value into the notch filter configuration information table (Table 2) associated with that channel. In the example notch filter configuration information index table (Table 3) illustrated in FIG. 11, the channel numbers associated with the band class are included in the “channel” column of the table. However, in some implementations, the channel numbers are not actually stored in the notch filter configuration information index table (Table 3). In such implementations, the channel numbers associated with a particular band class in sequential order and the data stored in the notch filter configuration information index table is also stored in sequential order based on the channel number associated with each entry in the table. Accordingly, it is possible to determine which row of the tables corresponds to the correct channel without actually storing the channel numbers in the table. For example, in the example of Table 3 illustrated in FIG. 11, the band class includes the following channels: 300, 301, 302, 303, and 304. Because the channels are sequential, the data associated with that channel can be determined based on the offset of the channel in the sequence of channels. For example, channel 302 is the third channel in the sequence of channels associated with the band class depicted in Table 3 of FIG. 11. Accordingly, by accessing the third row of the table, the proper index value (in this example “4”) associated with the channel can be obtained.

Each channel may have up to the maximum filter count number of entries associated with that channel in Table 2. For example, in a configuration where the mobile device can be configured to support up to 6 notch filters per channel, there may be up to six entries per channel in Table 2. Each band class that the WWAN transceiver of the mobile device 120 can support can have its own notch filter configuration information table (Table 2) and notch filter configuration information index table (Table 3).

If the selected row from the raw notch filter configuration information table will be the first entry for the current channel in the notch filter configuration information table (Table 2), a new row can be appended to the notch filter configuration information table (Table 2) (stage 715), and a new row can be appended to the notch filter configuration information index table (Table 3) that points to the newly added row in the notch filter configuration information table (Table 2) (stage 720). The index value in the row added to the notch filter configuration information index table (Table 3) represents the row number associated with the newly added row in the notch filter configuration information table (Table 2). A row counter variable can also be incremented (stage 730) that represents how many entries are currently in the notch filter configuration information table (Table 2) and can be used as the index value when adding entries to the notch filter configuration information index table (Table 3).

If the selected row from the raw notch filter configuration information table will not be the first entry for the current channel in the notch filter configuration information table (Table 2), a new row can be appended to the notch filter configuration information table (Table 2) (stage 725), and the row counter variable can be incremented (stage 730). The row counter variable represents the index value of the next row to be added to the notch configuration table (if any). The index value corresponds to the row number within the notch filter configuration information table (Table 2).

A determination can then be made whether the raw notch filter configuration information table includes any more rows to be added to the notch filter configuration information table (stage 735). If there are more rows to be added to the notch filter configuration information table, the process can continue with stage 705. Otherwise, the process can complete and optionally an alert can be generated that the notch filter configuration information table and the index table have been created successfully (stage 740).

FIG. 8 is a process for compensating for interference in a GNSS receiver of a mobile device using the interference compensation data generated in stage 310 of the process illustrated in FIG. 3. The process illustrated in FIG. 8 can be used to implement stage 315 at least in part or may be a standalone process for dynamically compensating for interference at the GNSS receiver at the mobile device. The process illustrated in FIG. 8 can be implemented in the mobile device 120, and can be implemented in the GNSS receiver of the GNSS interface 265 of the mobile device 120 and/or implemented as a processor-executable software module implemented software stored in a memory of the mobile device 120, such as the interference compensation module 1462. The notch filter configuration information can be determined using the interference compensation data described above. The interference compensation data can include at least one notch filter configuration information table and at least one notch filter configuration information index table associated with a band class to which the WWAN transceiver can be configured to operate. The notch filter configuration information can comprise frequency information that identifies the probable location of one or more spurs associated with a particular transmission band information and/or channel at which the WWAN transceiver may be operated. The notch filter configuration information can be used to dynamically configure the notch filters of the GNSS receiver. If the WWAN transceiver switches to a different transmission band information and/or channel, the notch filters can be dynamically reconfigured by accessing the appropriate notch filter configuration information from the interference compensation data associated with the new transmission band information and/or channel at which the WWAN transceiver is operating.

The interference compensation data can comprise a notch filter configuration information table (Table 2), such as that illustrated in FIG. 10, and a notch filter configuration information index table (Table 3), such as that illustrated in FIG. 11 for each of the band classes supported by the wireless transceiver of the wireless interface 225 the mobile device 120. The interference compensation data can be generated using the same or similar model of mobile device as the mobile device 120 that will be using the compressed header data files to configure the notch filters of the GNSS receiver of the GNSS interface 265. The compressed data header files that comprise the interference compensation data can be loaded into memory 260 or another memory associated with the mobile device 120 at the time that the mobile device is configured at the manufacturer or by a network service provider when the mobile device is configured to operate with the wireless communication network provided by the network service provider. The compressed header data files may also be downloaded to the mobile device 120. For example, the compressed data header files may be available for download as part of a device update provided by the manufacturer or by the network provider associated with the mobile device 120.

The process can begin with determining transmission band information and channel tuning information associated with an operating configuration of the wireless transceiver of the mobile device 120 (stage 805). In some implementations, the transmission band information and the channel tuning information can be received from the wireless transceiver of the wireless interface 225. For example, the wireless transceiver of the wireless interface 225 can be configured to output signal information that identifies the band class information and channel information for the band class and/or channel on which the wireless transceiver is operating or is about to switch to from a current band class and/or channel. For example, the wireless transceiver of the wireless interface 225 of the mobile device 120 can be configured to supply the band class information and channel information as the wireless transceiver is tuned to a new channel. The interference compensation module 1462 can be configured to receive the output signal information from the wireless transceiver.

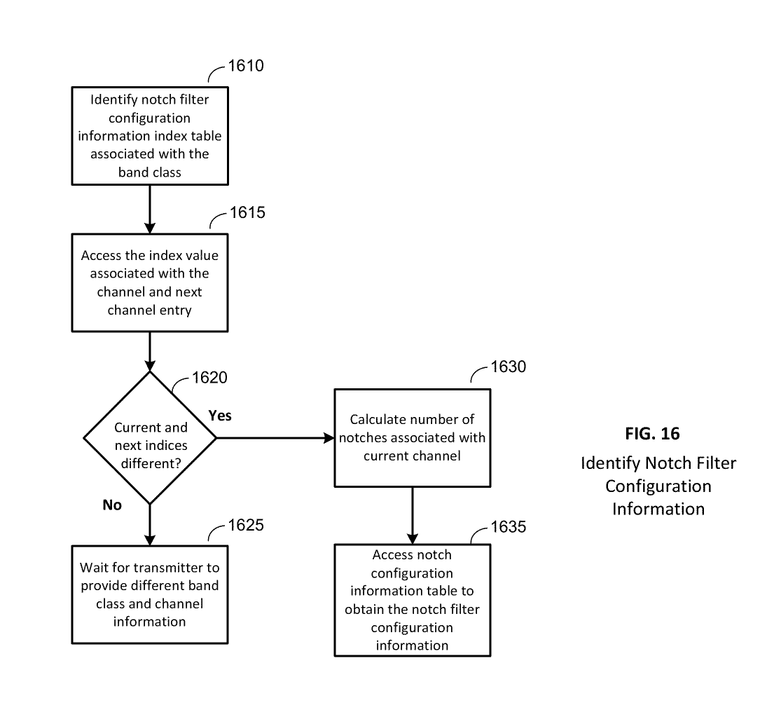

Notch filter configuration information can then be determined using the transmission band information and the channel tuning information for compensating for WWAN interference at the GNSS receiver (stage 810). The interference compensation module 1462 can be configured to determine notch filter configuration information that can be used to dynamically configure the notch filters of the GNSS receiver of the GNSS interface 265 based on the current operating configuration of the wireless transceiver of the mobile device 120. As the current operating configuration of the wireless transceiver changes, the notch filter configuration information for the new operating configuration can be determined. The process illustrated in FIG. 16 provides an example of one technique that can be used to determine the notch filter configuration information.

The GNSS receiver of the GNSS interface 265 of the mobile device 120 can then be configured to use the notch filter configuration information to dynamically configure notch filters for the GNSS receiver of the GNSS interface 265 for the current band class and current channel at which the WWAN receiver of the WWAN interface is operating (stage 815). The interference compensation module 1462 can be configured to configure the notch filters for the GNSS receiver of the GNSS interface 265 according to the notch filter configuration information accessed in the interference compensation data in stage 810. The interference compensation module 1462 can be configured to monitor to operating configuration of the wireless transceiver of the mobile device 120, and the process can return to stage 805 where new transmission band information and channel tuning information can be determined in response to the operating configuration of the wireless transceiver of the mobile device 120 changing.

The technique illustrated in FIG. 8 allows the interference compensation module 1462 to dynamically configure the notch filters in response to changes in the band class and/or channel to which the wireless transceiver of the wireless interface 225 of the mobile device 120 is tuned. The GNSS receiver can quickly adapt to changes in the band class and/or channel of the WWAN transceiver and configure the notch filters to a configuration that has been determined to be effective at eliminating interference generated by the wireless transceiver of the wireless interface 225 when operating using that band class and/or channel.

FIG. 16 is a flow diagram of a process that can be used to identify notch filter configuration information based on the transmission band information and the channel tuning information associated with an operating configuration of the wireless transceiver of the mobile device 120. The process illustrated in FIG. 16 can be used to implement stage 810 of the process illustrated in FIG. 8 at least in part or may be a standalone process for dynamically compensating for interference at the GNSS receiver at the mobile device. The process illustrated in FIG. 16 can be implemented in the mobile device 120, and can be implemented in the GNSS receiver of the GNSS interface 265 of the mobile device 120 and/or implemented as a processor-executable software module implemented software stored in a memory of the mobile device 120, such as the interference compensation module 1462.

The notch filter configuration information index table (Table 3) associated with the band class can be identified based on the transmission band information associated with the operating configuration of the wireless transceiver of the mobile device (stage 1610). Stage 1610 may be performed by the interference compensation module 1462 and the data access module 1464 of the mobile device 120. The interference compensation module 1462 can be configured to request that the data access module 1464 access the appropriate notch filter configuration information index table based on the band class and/or channel information received from the wireless transceiver of the wireless interface 225 of the mobile device 120. As indicated above, the Table 2 and Table 3 data may be stored in the memory 260 of the mobile device 120 or another memory associated with the mobile device in the form of compressed data header files. If no notch filter configuration index information table is found for the band class to which the wireless transceiver is tuned, then no notch configuration data is available for the band class and the process can terminate and the interference compensation module 1462 can be configured to wait for the wireless transceiver to tune to a different band class and/or channel.

As illustrated in FIG. 11, notch filter configuration information index table (Table 3) serves as an index into the notch filter configuration information table (Table 2). As discussed above, the example implementation illustrated in FIG. 11 includes the channel numbers for the band class associated with the notch filter configuration information index table (Table 3). However, other implementations of the notch filter configuration information index table (Table 3) can be configured to only include the “index” column of the table. In such implementations, the channels associated with the band class are a continuous sequence, and the offset of a particular channel with that sequence can be used to determine which row of the notch filter configuration information index table (Table 3) is associated with that channel. Translating between the channel number and the row index of the notch filter configuration information index table (Table 3) involves a quick offset operation that allows the index information to be quickly accessed for a particular channel.

If available, the notch filter configuration information index table can then be accessed to obtain the index value associated with the current channel and a next channel entry (if any) (stage 1615), and a determination can be made whether the indices associated with the current channel and the next channel entry are different (stage 1620). Stages 1615 and 1620 can be implemented by the interference compensation module 1462 of the mobile device 120. As indicated above, the notch filter configuration information table may be stored in the memory 260 of the mobile device 120 or another memory associated with the mobile device 120. The interference compensation module 1462 can request the appropriate notch filter configuration information index table from the data access module 1464, and the data access module 1464 can be configured to access the notch filter configuration information index table in the memory 260 or other memory associated with the mobile device 120.

If the indices associated with the current channel and the next channel entry are different, the current channel has notch filter configuration information associated with it stored in the notch filter configuration information table. If the indices are the same, then the current channel does not have notch filter data associated with it stored in the notch filter configuration information table. Referring now to FIG. 11 to illustrate this concept, assume that the wireless transceiver of the wireless interface 225 of the mobile device 120 has tuned to channel 302. The access of the indices form Table 3 with a given channel number is a direct random access process. To illustrate the process of obtaining the indices associated with a channel, suppose the channel is 302 and that the channel numbering starts at 300 for the band class in this example. In order to directly access the index for channel 302, the row number containing the index for channel 302 is determined by subtracting the starting channel number 300 from the current channel number 302 and adding one to that number, with the resulting row number 3 (302−300+1=3), which contains the index 4. Thus, the index associated with the current channel (channel 302) is 4, which indicates that the notch filter configuration information associated with channel 302 begins on row 4 of the notch filter configuration information table (Table 2). The index associated with the next channel (channel 303) is 7, which indicates that the data associated with channel 302 begins at row 4 and ends at row 6 of the notch filter configuration information table (Table 2) illustrated in FIG. 10.

To demonstrate how a channel that has no notch filter configuration information associated with it is represented in the notch filter configuration information index table (Table 3), assume that the wireless transceiver of the wireless interface 225 of the mobile device 120 has tuned to channel 303. The index of the next channel (channel 304) is 7 and the index associated with the current channel (channel 303) is also 7. This indicates that there is no notch filter configuration information associated with channel 303. We can see that in this particular example implementation channel 303 has no notch filter configuration information associated with it by referring back to Table 1 illustrated in FIG. 9.

If there is no notch filter configuration information for the channel, the process can continue by waiting for the wireless transceiver of the wireless interface 225 of the mobile device 120 to switch to a different band class and/or channel (stage 1625), at which time the process may terminate, or if implemented as part of the process illustrated in FIG. 8, the process may return to stage 805 and receiving band class information and channel information from the wireless transceiver of the wireless interface 225 of the mobile device 120.

If there is notch filter configuration information for the channel, the number of notches filter configurations associated with the channel can be calculated (stage 1630). In one implementation, the number of filter configurations associated with the current channel can be calculated by directly accessing the notch filter configuration information index table (Table 3) to find the next row that has a different index entry than the row associated with the current channel. This different index entry can be used to determine which rows of the notch filter configuration information table (Table 2) include notch filter configuration information for the current channel. Referring now to FIG. 11 to illustrate this concept, assume that the wireless transceiver of the wireless interface 225 has tuned to channel 302. The next entry that has a different index value is the row associated with channel 304. Channel 303 has no notch filter configuration information associated with it and thus the index is set the same as the next channel that has at least one notch filter configuration information entry associated with it, which in this case is channel 304. The index value associated with channel 304 indicates that the notch filter configuration information associated with channel 304 begins on row 7 of the notch filter configuration information table (Table 2). This indicates that the notch filter configuration information associated with channel 302 begins at row 4 of the notch filter configuration information table (Table 2) and ends at row 6 of the notch filter configuration information table (Table 2). If there are no more channel entries in the notch filter configuration information index table (Table 3) after the current channel entry, then the index associated with the current channel indicates the row of the notch filter configuration information table (Table 2) that the notch filter data associated with the current channel begins and any additional rows following the specified row through the end of the table are associated with the current channel. Referring now to FIG. 11 to illustrate this concept, assume that the wireless transceiver of the wireless interface 225 has been tuned to channel 304. Channel 304 is the last channel included in Table 3. The index indicates that the notch filter configuration information for channel 304 begins at row 7 of the notch filter configuration information table (Table 2). The notch filter configuration information table (Table 2) has 8 entries, so the entry in row 8 is also associated with channel 304.

Once the number of notches associated with the current channel is provided in the notch filter configuration information table (Table 2), the notch filter configuration information can be accessed in the notch filter configuration information table (Table 2) (stage 1635). The notch filter configuration information, once accessed, may be reformatted into a preferred format by the interference compensation module 1462. The notch filter configuration information, once accessed from the table can be used by the interference compensation module 1462 to configured the notch filters of the GNSS receiver of the mobile device 120.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media. The generic principles discussed herein may be applied to other implementations without departing from the spirit or scope of the disclosure or claims.

What is claimed is:

1. A method for compensating for interference in a Global Navigation Satellite System (GNSS) receiver of a mobile device, the method comprising:
determining transmission band information and channel tuning information associated with an operating configuration of a Wireless Wide Area Network (WWAN) transceiver of the mobile device;
identifying notch filter configuration information for compensating for WWAN interference at the GNSS receiver using the transmission band information and the channel tuning information; and
dynamically configuring notch filters of the GNSS receiver according to the notch filter configuration information.

2. The method of claim 1, further comprising:
receiving interference compensation data at the mobile device.

3. The method of claim 1 wherein identifying the notch filter configuration information using the transmission band information and the channel tuning information for compensating for the WWAN interference at the GNSS receiver further comprises identifying the notch filter configuration information based at least in part on interference compensation data comprising a notch filter configuration information table and a notch filter configuration information index table associated with a band class in which the WWAN transceiver can be configured to operate.

4. The method of claim 3 wherein identifying the notch filter configuration information using the transmission band information and the channel tuning information comprises:
accessing an index value in the notch filter configuration information index table, the index value being associated with a channel information derived from the channel tuning information received from the WWAN transceiver; and
accessing notch configuration data from the notch filter configuration information table using the index value from the notch filter configuration information index table.

5. The method of claim 4 wherein the dynamically configuring the notch filters of the GNSS receiver according to the notch filter configuration information further comprises:
configuring the notch filters of the GNSS receiver using the notch configuration data from the notch filter configuration information table.

6. A mobile device for compensating for interference in a Global Navigation Satellite System (GNSS) receiver of the mobile device, the mobile device comprising:
a tangible, non-transitory computer-readable memory;
a plurality of modules comprising processor executable code stored in the memory;
a processor connected to the memory and configured to access the plurality of modules stored in the memory; and
an interference compensation module configured to
determine transmission band information and channel tuning information associated with an operating configuration of a Wireless Wide Area Network (WWAN) transceiver of the mobile device;
identify notch filter configuration information for compensating for WWAN interference at the GNSS receiver using the transmission band information and the channel tuning information; and
dynamically configure notch filters of the GNSS receiver according to the notch filter configuration information.

7. The mobile device of claim 6 wherein the interference compensation module is further configured to:
receive interference compensation data at the mobile device.

8. The mobile device of claim 6 wherein the interference compensation module is configured to identify the notch filter configuration information based at least in part on interference compensation data comprising a notch filter configuration information table and a notch filter configuration information index table associated with a band class in which the WWAN transceiver can be configured to operate.

9. The mobile device of claim 8 wherein the interference compensation module is configured to identify the notch filter configuration information based at least in part on interference compensation data is further configured to:
access an index value in the notch filter configuration information index table, the index value being associated with a channel information derived from the channel tuning information received from the WWAN transceiver; and
access notch configuration data from the notch filter configuration information table using the index value from the notch filter configuration information index table.

10. The mobile device of claim 9 wherein the interference compensation module being configured to dynamically configure the notch filters of the GNSS receiver according to the notch filter configuration information is further configured to:
configure the notch filters of the GNSS receiver using the notch configuration data from the notch filter configuration information table.

11. A non-transitory computer-readable medium, having stored thereon computer-readable instructions for compensating for interference in a Global Navigation Satellite System (GNSS) receiver of a mobile device, the computer-readable instructions comprising instructions configured to cause a computer to:
determine transmission band information and channel tuning information associated with an operating configuration of a Wireless Wide Area Network (WWAN) transceiver of the mobile device;
identify notch filter configuration information for compensating for WWAN interference at the GNSS receiver using the transmission band information and the channel tuning information; and
dynamically configure notch filters of the GNSS receiver according to the notch filter configuration information.

12. The non-transitory computer-readable medium of claim 11 further comprising instructions configured to cause the computer to:
receive interference compensation data at the mobile device.

13. The non-transitory computer-readable medium of claim 11 wherein the instructions configured to cause the computer to identify the notch filter configuration information using the transmission band information and the channel tuning information for compensating for the WWAN interference at the GNSS receiver further comprise instructions configured to cause the computer to identify the notch filter configuration information based at least in part on interference compensation data comprising a notch filter configuration information table and a notch filter configuration information index table associated with a band class in which the WWAN transceiver can be configured to operate.

14. The non-transitory computer-readable medium of claim 13, wherein the instructions configured to cause the computer to identify the notch filter configuration information using the transmission band information and the channel tuning information further comprise instructions configured to cause the computer to:
access an index value in the notch filter configuration information index table, the index value being associated with a channel information derived from the channel tuning information received from the WWAN transceiver; and
access notch configuration data from the notch filter configuration information table using the index value from the notch filter configuration information index table.

15. The non-transitory computer-readable medium of claim 14, wherein the instructions configured to cause the computer to dynamically configure the notch filters of the GNSS receiver according to the notch filter configuration information further comprise instructions configured to cause the computer to:
configure the notch filters of the GNSS receiver using the notch configuration data from the notch filter configuration information table.
